(19) United States
(12) Patent Application Publication
(10) Pub. No.: US 2015/0176896 A1
(43) Pub. Date: Jun. 25, 2015

(54) Method for Drying and/or Crystallizing Bulk Material and Device for Performing such a Method

(71) Applicant: Motan Holding GmbH, Konstanz (DE)

(72) Inventors: Holger Kühnau, Konstanz (DE); Thomas Kaupel, Friedberg (DE)

(21) Appl. No.: 14/574,465

(22) Filed: Dec. 18, 2014

(30) Foreign Application Priority Data
Dec. 18, 2013 (DE) 10 2013 022 092.0

(51) Int. Cl. F26B 5/04

(52) U.S. Cl. CPC F26B 5/041

(57) ABSTRACT

In a method for drying and/or crystallizing bulk material, a drying medium is passed through bulk material present in a drying chamber and the drying chamber with the bulk material is put under a partial vacuum at least for part of a drying time of the bulk material. A device for performing the method has at least one drying container with a drying chamber for bulk material, at least one supply line for a drying medium connected to the at least one drying container, and at least one return air line connected to the at least one drying container. At least one partial-vacuum generator is provided to put at least the drying chamber under a partial vacuum at least for part of a drying time of the bulk material.

### BACKGROUND OF THE INVENTION

The invention relates to a method for drying and/or crystallizing bulk material, in particular plastic granulate, wherein a drying medium flows through the bulk material present in at least one drying chamber, and a device for performing such a method, with at least one drying container for the bulk material, to which at least one supply line for the drying medium and at least one return air line are connected.

It is known to heat and dry bulk materials by means of a dry gas flow, whereby the bulk material in the vertical drying container is introduced continuously or batch-wise at the top into the drying container and is discharged again at the bottom in a similar manner. The drying container is preferably always completely filled with bulk material. The drying medium used to dry the bulk material is usually introduced from below into the drying container and conveyed in the counter-flow through the bulk material. The bulk material and the moisture contained in the bulk material are heated by the drying medium, which expels the moisture from the bulk material.

The drying medium, which flows in the counter-flow from the bottom wards through the bulk material, dehumidifies the bulk material only slowly, because the drying medium introduced from below releases energy on the path through the drying container and the temperature of the drying medium therefore also drops on the path through the bulk material. A temperature gradient of the bulk material thus arises in the drying container, said temperature gradient being orientated towards the energy input via the hot drying medium. In the case of a low specific drying medium quantity relative to the bulk material throughput, the temperature will fall more rapidly towards the top in the drying container than in the case of a high specific air quantity. Since the drying medium also takes up moisture from the bulk material during the passage through the bulk material, the drying medium becomes more humid on the path through the bulk material, as a result of which the drying capacity also diminishes.

In order to dry the bulk material more quickly, drying containers are also known that comprise two pipes, between which a bulk material chamber is formed and which are each constituted as perforated pipes. The drying medium is introduced into the internal pipe. It flows through the holes of the internal pipe outwards, flows through the bulk material and thereby takes up moisture from the bulk material and heats it. The drying medium then flows out through the holes of the external pipe into the container interior and flows to an outlet. Since the drying medium flows through the bulk material normal to the axis of the drying container, only short drying times result. The effect of the cross-flow is that the same drying temperature and therefore also the same minimum dew point of the drying medium is present in every plane.

Devices for drying and crystallizing plastics are also known, wherein a very large quantity of drying medium flows through the plastics from beneath in a fluidized bed. The bulk material is thereby lifted and then behaves like a fluid. This mode of procedure preferably takes place in a batch process, wherein at all times only the quantity of bulk material present in the drying container is treated and then completely discharged. Continuous processes are only possible with these devices if the specific density of the materials, for example, changes so markedly as a result of the treatment that they can be separated, for example, by means of an air separator. The area of application of these devices is therefore limited.

Furthermore, it is known to dry the bulk material under vacuum. The devices used for this are usually operated only in a batch-wise manner. A quantity of material is heated here in one station, dried in a following station by means of vacuum or under pressure and, after the drying, is fed out of a storage container for processing in an atmospheric environment to the processing process.

Devices are also known, with which the dehumidification is carried out continuously. The process steps are split up into series-connected partial processes. The bulk material is first heated and conveyed into a vacuum container, for example, by means of a rotary lock valve. Located beneath the vacuum container is a further lock valve, with which the material is conveyed out again after the treatment in the vacuum container.

The object underlying the invention is to configure the method of the aforementioned kind and the device of the aforementioned kind in such a way that the drying times for the bulk material can be considerably shortened with a straightforward structural design and process management.

### SUMMARY OF THE INVENTION

This object is solved in the case of the method of the aforementioned kind in accordance with the invention in that the drying chamber with the bulk material is put under a partial vacuum at least for part of the drying time. In the case of the device of the aforementioned kind, this object is solved in accordance with the invention in that the device is provided with at least one partial-vacuum generator, with which at least the drying chamber in the drying container is put under a partial vacuum at least for part of the drying time.

In the method according to the invention, the drying chamber in which the bulk material is present for treatment is put under a partial vacuum at least for part of the drying time. In connection with the flow of the drying medium through the bulk material, optimum drying of the bulk material results within the shortest possible time.

It is advantageous if the bulk material is alternately acted upon by the drying medium and a partial vacuum. The drying medium is conveyed through the bulk material in a first phase. In a second phase, the supply of the drying medium is interrupted and the device is switched over by means of a valve control in such a way that a partial vacuum arises at least in the drying chamber, said partial vacuum being maintained for a specific time. The duration can be fixedly preset, but can also be varied depending on a measured degree of humidity. After termination of the partial vacuum phase, the device is again switched over by means of the valve control so that the drying medium flows through the bulk material.

Optimum drying of the bulk material results due to the constant switching between the partial vacuum phase and the heating or drying phase.

The bulk material can also be acted upon simultaneously by the drying medium and the partial vacuum. This is advantageously achieved by the fact that an additional partial-vacuum generator, preferably a blower, is used, to which a filling device of the drying container is connected in the system circuit. The partial vacuum increases the vapor pressure difference between the drying medium and the bulk material to be dried, which advantageously contributes to a short drying time.

The drying medium is advantageously conveyed in the circuit through the drying container. Part of the drying medium is fed to a dehumidification device after it has flowed through the bulk material. Since at all times only a part of the drying medium is fed to the dehumidification device for dehumidification, the energy expenditure can be kept low.

Since the dehumidification device is advantageously disposed only in an auxiliary flow, the total quantity of the drying medium does not have to be dehumidified. A heat exchanger is advantageously inserted between the removal and supply of the partial flow of the drying medium, in order to make optimum use of the thermal energy contained in the partial flow of the drying medium.

The part of the drying medium dehumidified in the dehumidification device is advantageously fed back to the drying medium flowing towards the drying container.

With advantageous process management, the temperature of the drying medium is set to a temperature adapted to the bulk material by means of at least one heating device and at least one temperature sensor via a control device.

In a device according to the invention, at least one partial-vacuum generator is provided, which puts at least the drying chamber of the drying container under a partial vacuum.

The partial-vacuum generator is advantageously a blower, at the suction side whereof a filling device is connected for the bulk material.

In an advantageous embodiment, the device has a valve control, with which the partial-vacuum generator can be switched over in such a way that it conveys air out of the air circuit of the device and the drying container outwards to the surrounding space. A partial vacuum thus arises in the entire flow space and therefore also in the drying chamber.

A material lock is advantageously connected to the outlet of the drying container, said material lock comprising two valves between which an intermediate space is disposed for the bulk material. With such an embodiment of the device, it is possible to remove bulk material from the drying container while a partial vacuum is present in the device.

In an advantageous embodiment, the outlet of the drying container is connected via at least one line to a melting zone of a processing machine for the bulk material. The partial vacuum prevailing in the melting zone ensures that outgassing moisture or other volatile substances can still be removed from the bulk material at the start of the melting phase.

In another embodiment according to the invention, the drying container is constituted in such a way that the drying medium enters into the drying chamber in such a way that the bulk material in the drying chamber is always acted upon only partially by the drying medium. The drying medium is introduced in such a way that it acts only on a part of the bulk material in the drying chamber.

It is thus possible to allow the drying medium to flow at a high speed into the bulk material, as a result of which very short drying times result for the bulk material. The drying medium is advantageously conveyed through the bulk material transversely to the direction of motion of the bulk material flow in the drying container, as a result of which short drying times result in the optimum manner. The drying medium can be fed not only continuously, but also in a phased manner for the drying and/or crystallizing of the bulk material. In this case, the drying medium can be introduced at a particularly high speed into the bulk material. This phased process management also enables a high diffusion rate of the moisture out of the bulk material. In addition, sliding-down of the bulk material is achieved through the rest phases between the introduction of the drying medium, which bulk material might otherwise be left behind in the drying container, especially when a very high speed of the drying medium is employed. The overall drying unit can thus be designed small, which offers a considerable advantage in the handling of the bulk material.

Built-in components are advantageously provided on one of the two pipes of the drying container, by means of which built-in components a partial through-flow of the drying medium through the bulk material is carried out.

In an advantageous embodiment, these built-in components can be constituted by an inner pipe or outer pipe which is mounted rotatably in the internal pipe or on the external pipe of the drying container.

The inner/outer pipe comprises here at least one, preferably a plurality of through-openings for the passage of the drying medium. The drying medium can flow into the bulk material via this through opening.

The internal or the external pipe is advantageously a perforated pipe, the holes whereof are covered by the inner pipe or the outer pipe, up to the region of the through-opening(s). The drying medium can thus flow into the bulk material only through the through-opening of the rotatable inner or outer pipe and the holes of the internal or external pipe lying in this region. The remaining holes of the internal or external pipe are covered by the inner or the outer pipe. It is thus possible to make provision very easily such that the bulk material is acted upon only partially by the drying medium. Since the inner or the outer pipe is rotated about its axis, the flow of drying medium exiting out of the through-opening passes into all regions of the bulk material with a 360° rotation.

The through-opening of the inner or outer pipe can, for example, be a slot-shaped opening extending over the length of the pipe. If the inner or outer pipe is rotated about its axis, the drying medium is acted upon partially by the drying medium successively over its entire height.

It is however also possible to provide a plurality of through-openings over the height and/or the circumference of the inner or the outer pipe. In this case, too, the bulk material is acted upon completely in the bulk material annular space with a 360° rotation of the inner or outer pipe.

A drive is provided for the rotation of the inner or outer pipe, said drive being able to be located outside, but also inside the drying container.

The through-opening of the inner or outer pipe is advantageously several times larger than the holes of the internal or external pipe. A sufficiently wide flow of drying medium can thus be conveyed into the bulk material to be dried.

In another advantageous embodiment, at least one screen is used as a built-in component, which is axially displaceable in the internal pipe or on the external pipe. The internal or the external pipe is constituted here as a perforated pipe. The screen covers the holes of the pipe over which it extends, so that no drying medium can pass through these covered holes of the pipe. Depending on the width of the screen, it is thus readily possible to establish the size of the drying medium flow exiting through the internal pipe or entering via the external pipe. The screen is displaced in the axial direction of the internal or external pipe, so that different regions of the internal or external pipe are successively covered or different regions for the passage of the drying medium are successively freed. In this way, the whole of the bulk material in the bulk material annular space is gradually covered by the drying medium.

The screen is advantageously fixed on a piston rod, which projects into the internal pipe or into the drying container. The piston rod, for its part, sits on a piston, which is advantageously part of a pneumatic drive.

The drive can be disposed inside or outside the drying container.

Any suitable drive can be used as a drive for the screen.

It is advantageous if two or more screens lying spaced apart from one another are present in the internal pipe or on the external pipe, said screens advantageously being able to be displaced together axially inside the internal pipe or on the external pipe. The drying medium can then enter through the holes of the internal or external pipe into the bulk material in the region between the two screens arranged one behind the other.

In a further advantageous embodiment, the built-in components are constituted by at least one stirrer blade, which projects from the internal or external pipe into the bulk material annular space. The internal or the external pipe can thereby be rotated about its axis. As a result of the rotation of the pipe, the bulk material itself is subjected to a motion. The drying medium thus passes into a correspondingly loosened region of the bulk material, as a result of which the formation of agglomerates during the crystallization of the bulk material is prevented.

In order to achieve an optimum effect, it is advantageous here if a plurality of stirrer blades are provided over the length of the internal or external pipe. The bulk material is then subjected simultaneously to a motion at a plurality of points, which contributes to the advantageous short drying time.

In order that the bulk material itself is not caused to rotate, at least one blade projects from the inner wall of the external pipe or the outer wall of the internal pipe into the bulk material annular space. In contrast with the stirrer blade, this blade is stationary and prevents the bulk material from being rotated due to the rotation of the pipe with the stirrer blade.

The stationary blade of the one pipe, viewed in the axial direction of both pipes, overlaps the stirrer blade of the other pipe. An optimum effect of both blades is thus ensured.

In a further advantageous embodiment, the stirrer blade is a hollow body, into which the drying medium flows and which comprises at least one outflow opening for the drying medium. In this case, the pipe does not have to be perforated, since the drying medium passes via the hollow body and its outflow opening into the bulk material. The stirrer blade thus serves not only to set the bulk material in motion within the region of its action, but also to introduce the drying medium into the bulk material in a targeted manner in this region.

The diameter of the perforated internal or external pipe can advantageously be constituted in a differing manner. The effect of this is that the radial width of the bulk material annular space can be varied. The thickness of the bulk material is thus changed and the relative motion of the individual bulk material granulates is markedly increased with a small bulk material thickness. This leads advantageously to a reduced agglomerate formation during crystallization.

In addition, the drying time is thus considerably reduced.

In a further advantageous embodiment, the internal or external pipe is a perforated pipe, which can be rotated about its axis by means of a drive. In this embodiment of the drying container, no stirrer blades are needed to cause the bulk material to move.

The subject-matter of the application emerges not only from the subject-matter of the individual claims, but also from all the data and features disclosed in the drawings and the description. Even though they are not the subject-matter of the claims, they are claimed as essential to the invention, insofar as they are novel individually or in combination with respect to the prior art.

### BRIEF DESCRIPTION OF THE DRAWINGS

Other features of the invention emerge from the further claims, the description and the drawings.

FIG. 1 shows, in a diagrammatic representation, a device for drying and heating of plastic granulate with a drying container according to the invention.

FIG. 1 a shows a radial cross-section through the drying container according to FIG. 1.

FIG. 1b shows an axial cross-section through the drying container according to FIG. 1.

FIG. 2a shows, in the radial and in the axial cross-section, a further embodiment of a drying container according to the invention in a first through-flow direction of the drying medium.

FIG. 2b shows the drying container according to FIG. 2a in a second through-flow direction of the drying medium.

FIG. 2c shows, in the radial and in the axial cross-section, a further embodiment of the drying container according to the invention.

FIG. 3 shows, in the radial and in the axial cross-section, a further embodiment of a drying container according to the invention.

FIG. 3a shows, in a radial and in an axial cross-section, a further embodiment of a drying container according to the invention.

FIG. 4 and FIG. 5 show further embodiments of drying containers according to the invention in representations according to FIG. 2a.

FIGS. 6 to 8 each show, in a diagrammatic representation corresponding to FIG. 1, embodiments of devices according to the invention for the drying and heating of plastic granulate.

FIG. 9a shows, in the radial and in the axial cross-section, a further embodiment of a drying container according to the invention in a first through-flow direction of the drying medium.

FIG. 9b shows the drying container according to FIG. 9a in a second through-flow direction of the drying medium.

FIG. 10 to FIG. 12 show further embodiments of devices according to the invention.

### DESCRIPTION OF PREFERRED EMBODIMENTS

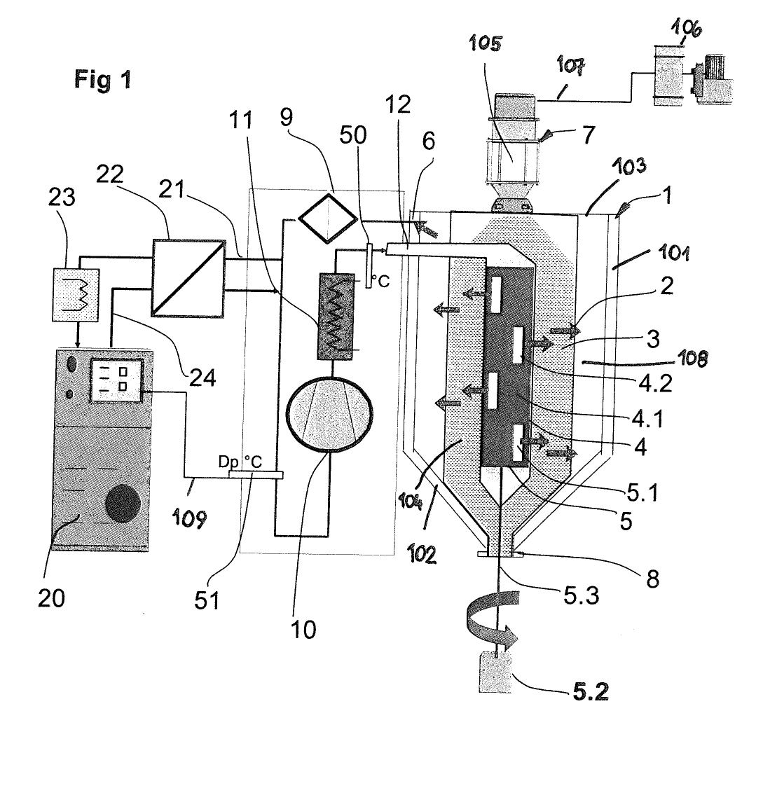

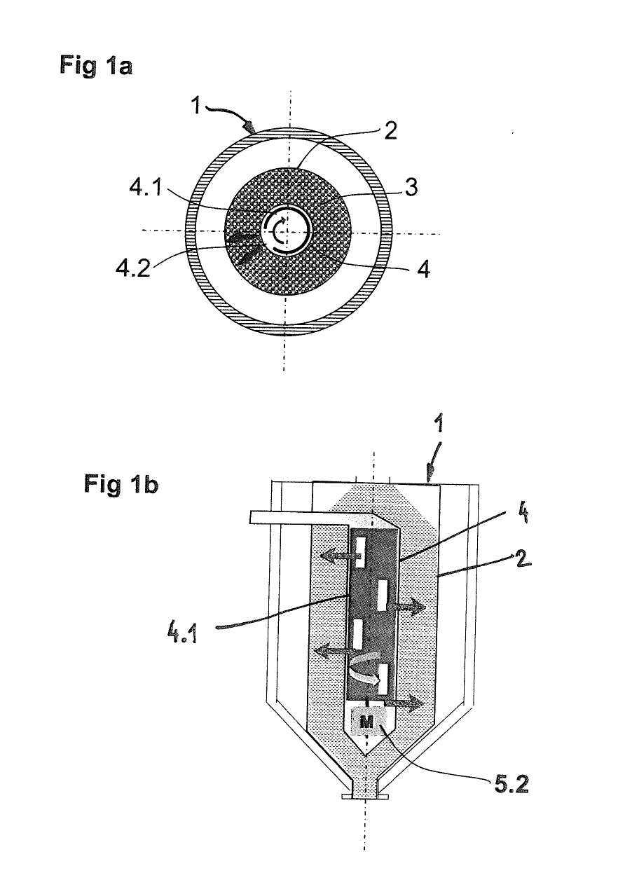

The device is used to reduce substantially the pass-through time for the drying and/or the crystallization of bulk material in a drying container by means of rapid heating and special process management. The device according to FIG. 1 has at least one drying container 1, which comprises a cylindrical mantle 101, which transforms into a conical mantle 102 at the lower end of container 1. Located in conical mantle 102 at the lower end is an outlet 8, via which bulk material 3 dried in container 1 is removed.

Two pipes 2 and 4 lying coaxial relative to one another are located centrally in container 1. External pipe 2 extends from a cover 103 closing off cylindrical mantle 101 at the upper end up to conical mantle 102. Internal pipe 4 is spaced apart from cover 103 and from conical mantle 102 of heating container 1.

Bulk material 3 to be dried is introduced by means of a filling device 7 from cover 103 into an annular space 104, which extends between the two pipes 2, 4. In order that bulk material 3 does not pass into internal pipe 4, it is closed at the top. Internal pipe 4 is also sealed off at the bottom in such a way that bulk material 3 cannot pass via the lower end into internal pipe 4. Filling device 7 sits on cover 103 and is constituted in a known manner. It comprises at least one conveying container 105, which is fitted on container 1 to be filled. Filling device 7 is also provided with a vacuum station 106, which is connected to conveying container 105 by at least one line 107. The bulk material is located in at least one (not represented) collecting container, which can be constituted as a silo, as a box or as any container that can be filled with bulk material.

The bulk material is introduced by means of filling device 7 from above into annular space 104 between the two pipes 2, 4, until container 1 is filled to the maximum. Outlet 8 is closed in a known manner, for example, by means of a slide gate. Bulk material 3 can be heated rapidly in container 1, moisture present in the bulk material being removed. It is also possible with container 1 to convert bulk materials such as, for example, PET (polyethylene terephthalate), from the amorphous into the crystalline state. As soon as bulk material 3 has been sufficiently treated in container 1, it is discharged from container 1 via outlet 8. Treated bulk material 3 can be removed from container 1 continuously or in batches. Corresponding to the quantity of bulk material removed from container 1, topping up with new bulk material is advantageously always carried out with filling device 7 in such a way that annular space 104 is always completely filled.

The throughput of bulk material 3 is adjusted in such a way that bulk material 3 is present an annular space 104 for a defined time. This dwell time in annular space 104 preferably lies between approx. 0.2 and approx. 8 hours. The dwell time is adapted to the nature of the bulk material and/or to its moisture content. The dwell time is selected such that the bulk material has an optimum degree of dryness, without the bulk material being damaged, for example, fused, due to an excessively long and/or an excessively high drying temperature. If the bulk material has a high moisture content, the dwell time in annular space 104 is longer than in the case of a less moist bulk material.

The two pipes 2, 4 are constituted as perforated pipes, so that the drying air that is required for the drying of bulk material 3 can pass through the openings of the pipes to the bulk material and can flow out of the bulk material. The openings of pipes 2, 4 are smaller than the grain size of the bulk material, so that the bulk material from annular space 104 cannot pass outwards through the external pipe or through the openings of internal pipe 4 into the internal pipe.

The drying air required for the treatment of the bulk material is fed via a line 12 to internal pipe 4. The drying air is brought to the required drying temperature by means of at least one heating device 11 if this is required. Drying air is preferably used as a drying medium, although it can also be any suitable drying gas. A temperature sensor 50 sits in line 12, with which the temperature of the drying medium can be detected before entry into container 1.

Connected upstream of heating device 11 is a blower 10, which feeds the drying medium to container 1.

The drying medium passes via line 12 into internal pipe 4. The drying medium flows over the length and over the circumference of internal pipe 4 through its openings radially outwards, which is illustrated by the drawn flow arrows. The drying medium flows radially through the bulk material present an annular space 104 and passes through the openings of external pipe 2 into annular space 108, which is limited radially by external pipe 2 and cylindrical mantle 101 of container 1. When it passes through bulk material 3, the drying medium takes up the moisture. A return line 6 is connected close to the cover region of container 1, via which return line the return air loaded with moisture is sucked away by means of blower 10. This return air loaded with moisture flows through a filter 9 and is fed to blower 10. Part of the return air is branched off via a line 21 in order to feed this part to a dehumidification device 20. A heat exchanger 22, downstream of which a cooler 23 is connected, sits in line 21. It is advantageously operated with cooling water and cools down the return air. The return air then passes into dehumidification device 20, with which the moisture of the partial quantity of the return air is removed in a known manner. The dehumidified part of the return air flows via line 24 via a second part of heat exchanger 22 back into return line 6, in which the cooled and dehumidified part of the return air mixes with the return air flowing directly via line 6 to the blower, which is not dehumidified or cooled. Since only a part of the return air from container 1 is branched off via a line 21, the energy requirement for cooling and/or dehumidification can be kept small.

Instead of dehumidification device 20, relaxed compressed air or another dehumidification process which enables dehumidification of the return air can be used for the dehumidification of the return air.

The drying medium is conveyed in the circuit through the device in the described manner, wherein at all times only part of the return air loaded with moisture undergoes the dehumidification process. A moisture sensor 51 is used to determine the moisture content in return line 6, said moisture sensor being connected to dehumidification device 20 via a signal line 109. The moisture content in the drying medium can be regulated by moisture sensor 51 in such a way that it remains approximately constant or does not exceed a preset moisture content. In order to obtain this advantageous embodiment, dehumidification device 20 can advantageously be controlled. The control has the advantage that moisture is removed from the return air only when the moisture content measured in the return line exceeds the preset value. If bulk material 3 contains only a little moisture, the dehumidification process can be carried out in a very cost- and energy-saving manner. Since the drying medium also heats up during its passage through the bulk material, the thermal energy is utilized by means of heat exchanger 22.

The nature of the drying medium depends on the given bulk material 3. External air is sufficient as a drying medium for bulk materials for the further processing of which a small residual moisture content is not necessary. It is conveyed at the preset drying temperature through bulk material 3 in the described manner. If the bulk material is constituted by highly hygroscopic plastics for the further processing of which only a small residual moisture content is permitted, simple external air is not sufficient. In this case, drying air or another suitable drying gas is used.

Moisture sensor 51 can also transmit its signals wireless to dehumidification device 20.

Installed inside internal pipe 4 is a further pipe 4.1, which is driven rotatably by a drive 5.2. This pipe 4.1 sits on a shaft 5.3, which is connected in a driven manner to drive 5.2. Drive 5.2 can be disposed outside or also inside container 1. Any suitable motor can be used as drive 5.2, preferably an electric motor. Shaft 5.3 and therefore pipe 4.1 is rotated at low speed about its axis. The speed is determined according to the nature of bulk material 3 present an annular space 104.

Inner pipe 4.1 has only a small spacing from the inner casing of internal pipe 4. The spacing is only so large that inner pipe 4.1 can reliably rotate about its axis.

As emerges from FIG. 1, rotatable inner pipe 4.1 is provided with openings 4.2 which, in the embodiment, are rectangular openings disposed upright. The openings are disposed above one another in rows, which have a small spacing from one another in the longitudinal direction of pipe 4.1. At least two, but also more than two such openings 4.2 can be provided inside each circumferential section, distributed over the circumference. Openings 4.2 of one row are disposed offset with respect to openings 4.2 of the adjacent row in the circumferential direction of pipe 4.1. In the embodiment, openings 4.2 of every other row lie at the same axial height. The offset of openings 4.2 in the individual rows with respect to one another is arbitrary.

The shape of openings 4.2, their number and their arrangement on pipe 4.1 can be selected depending on bulk material 3 to be dried. Inner pipe 4.1 ensures that drying medium does not flow through bulk material 3 uniformly over its height and its circumference, but in each case in a partial manner. Since pipe 4.1 is rotated about its axis, the drying medium passes into bulk material 3 at constantly changing points. The points of pipe 4.1 outside openings 4.2 cover the openings of surrounding pipe 4, so that the drying medium fed via line 12 can flow only in the region of openings 4.2 radially outwards into bulk material 3. Since pipe 4.1 rotates about its axis during the drying/crystallization process, the input of the drying medium into bulk material 3 takes place at constantly changing points. The whole of bulk material 3 is thus not acted upon by the drying medium over its height, so that the part of the bulk material through which drying air is not currently flowing remains at rest. Reliable sliding-down of bulk material 3 is thus achieved, so that reliable removal of the bulk material via outlet 8 is ensured. The drying medium can be fed to bulk material 3 at high speed, so that the drying time is considerably shortened. The fact that the drying medium flows radially through the bulk material over a height also contributes towards this.

As FIG. 1 shows for an opening 4.2, exiting drying medium flow 110 is conveyed in the direction of the arrow into bulk material 3 through 360° by rotation of pipe 4.1. The openings in pipe 4 are covered by pipe 4.1 in the region outside opening 4.2, so that at these points no drying medium can pass into bulk material 3. Since openings 4.2 are disposed in a plurality of rows one above the other and also offset with respect to one another in the circumferential direction of pipe 4.1, a partial flow of the drying medium exiting from respective openings 4.2 thus always takes place through bulk material 3. As a result of such guidance of the drying medium, it is possible to achieve particularly effective drying or crystallization of the bulk material which takes only a short time.

As emerges from FIG. 1a, only one opening 4.2 is provided in each circumferential section of pipe 4.1. Depending on the application, two or more openings 4.2 with a spacing behind one another in the circumferential direction can also be provided in each circumferential section. Such an embodiment of pipe 4.1 is suitable with a correspondingly large diameter of pipe 4.1 or 4.

FIG. 1b shows a variant in which drive 5.2 is located in container 1. In the embodiment represented in Fig.1, drive 5.2 lies outside the container.

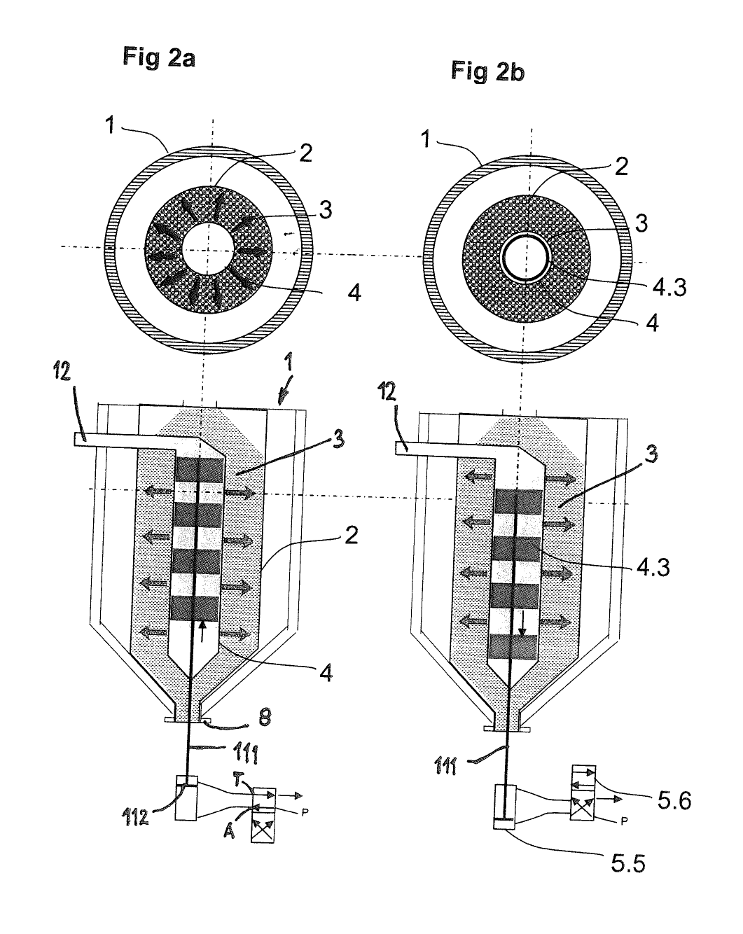

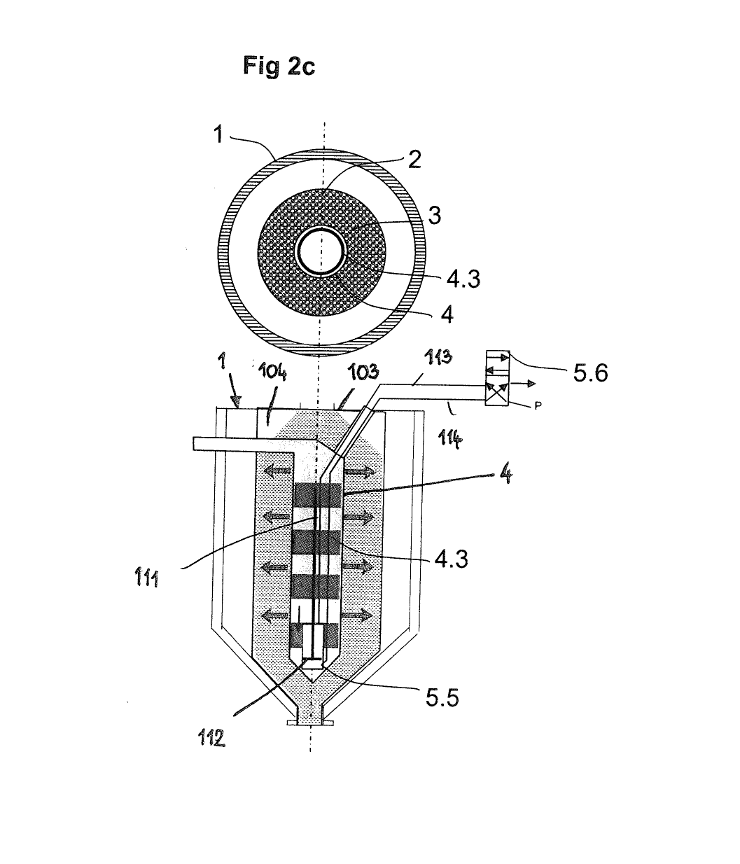

The partial air supply over the height of internal pipe 4 and over its length can also be achieved when no rotatable inner pipe 4.1 is used (FIGS. 2a and 2b). In this embodiment, at least one tubular screen 4.3 is provided in internal pipe 4, said screen being movable axially inside pipe 4. In the embodiment, four tubular screens 4.3 lying above one another at a spacing are provided in pipe 4, said diaphragms sitting on a common piston rod 111. Diaphragms 4.3 can be displaced together axially inside pipe 4 by means of said piston rod. The tubular diaphragms have only a small spacing from the inner wall of pipe 4, so that diaphragms 4.3 can be reliably adjusted. The spacing is so small or the region between diaphragms 4.3 and the inner wall of pipe 4 is sealed such that the drying medium fed via line 12 into pipe 4 cannot pass between the inner wall of pipe 4 and diaphragms 4.3. The drying medium can thus flow through the openings of pipe 4 radially outwards into bulk material 3 only in the region between diaphragms 4.3 lying one above the other, as is indicated by the flow arrows. Since screens 4.3 are axially adjustable in pipe 4, different regions of pipe 4 are freed for the passage of the drying medium depending on the position of diaphragms 4.3.

Piston rod 111 projects into a pneumatic cylinder 5.5 which can be actuated by means of a switching valve 5.6. Piston 112 in pneumatic cylinder 5.5 can be acted upon from both sides. In the switching position according to FIG. 2a, the pressure medium is introduced via working connection A of switching valve 5.6 into pneumatic cylinder 5.5 in such a way that piston 112 is moved upwards. The pressure medium present in the other cylinder chamber is fed back to the tank via tank connection T of switching valve 5.6. Screens 4.3 sitting on piston rod 111 are correspondingly moved into the upper position represented in FIG. 2a. The drying medium flows in the direction of the drawn flow arrows in the region between screens 4.3 through pipe 4 radially into bulk material 3.

If switching valve 5.6 is switched over (FIG. 2b), the pressurized medium passes into the upper cylinder chamber, as result of which piston 112 is displaced downwards. The pressure medium present in the lower cylinder chamber is conveyed back to the tank. Diaphragms 4.3 are displaced by means of piston rod 111 into the other end position, in which screens 4.3 cover the regions of pipe 4 lying free in the switching position according to FIG. 2a. The drying medium now flows into bulk material 3 via the regions of pipe 4 which are covered by the screens in the switching position according to FIG. 2a.

In this embodiment, bulk material 3 is once again acted upon by the drying medium upon only in sections. Switching valve 5.6 can be switched over each time at identical time intervals in order to move screens 4.3 into the position according to FIG. 2a or into the position according to FIG. 2b. Depending on bulk material 3, however, it is also possible to switch over switching valve 5.6 in alternating time intervals.

The spacing between adjacent screens 4.3 advantageously corresponds to the width of screens 4.3. The effect of this is that, depending on the switching position, those regions of pipe 4 are always covered through which the drying medium flows into bulk material 3 in the respective other switching position.

It is in principle possible to select the spacings between screens 4.3 smaller than or larger than the width of the screens.

Piston rod 111 projects through outlet 8 of container 1 outwards.

Not only pneumatic drives, but also all suitable drives can of course be considered for the axial adjustment of screens 4.3.

In the embodiment according to FIG. 2c, piston rod 111 is located completely inside pipe 4. Pneumatic cylinder 5.5 is also provided inside pipe 4 at its lower end. Only switching valve 5.6 is located outside of container 1. Lines 113, 114 for the pressure medium that are provided for the actuation of piston 112, which can be acted upon on both sides, are led from switching valve 5.6 in a sealed manner through cover 103 to pneumatic cylinder 5.5. Lines 113, 114 are led in a sealed manner through annular space 104 into pipe 4.

Switching valve 5.6 is advantageously a 4/2 switching valve. Piston 112 and therefore piston rod 111 can be reliably displaced between the two end positions by means of said switching valve.

As in the previous embodiment, screens 4.3 for the phased through-flow of bulk material 3 are switched back and forth in an arbitrary manner by means of switching valve 5.6. Moreover, the embodiment according to FIG. 2c is constituted in the same way as the embodiment according to FIGS. 2a and 2b.

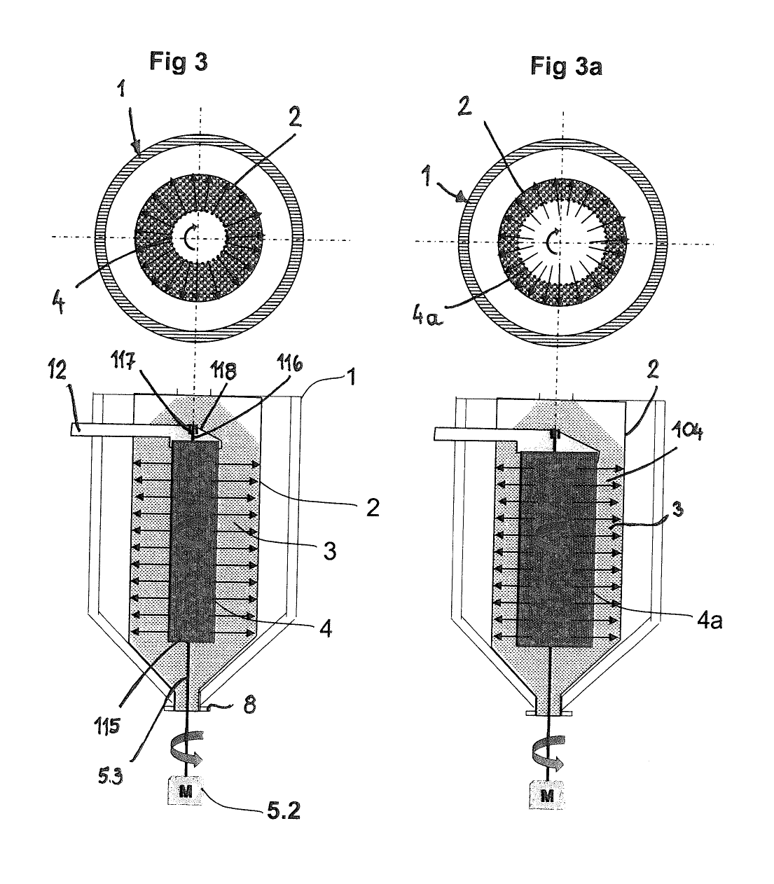

The embodiment according to FIGS. 3 and 3a is advantageously used for crystallization or for improved mixing during the drying of bulk material 3. In this embodiment, pipe 4 itself is rotated about its axis. The drying medium fed via line 12 is conveyed into the interior of pipe 4 and flows through the openings of the pipe over its axial height radially into bulk material 3. Pipe 4 can be provided over its entire height and over its entire circumference with the through-openings for the drying medium. In principle, however, it is also possible to provide the perforations only over a part of the circumference of pipe 4. The perforations can be provided here, for example, over the same partial circle, viewed in the axial direction, on the pipe. It is however also possible to provide the perforations, for example, in the form of a helix on internal pipe 4 or to provide the perforations, similar to openings 4.2 of the embodiment according to FIG. 1, in sections over the length of pipe 4. The partial subjection of bulk material 3 to the drying medium has the advantage of very rapid heating, crystallization and drying of bulk material 3.

This effect is further enhanced by the fact that, as result of the rotation of internal pipe 4, the bulk material itself is set into a relative motion between fixed external perforated pipe 2 and rotating perforated internal pipe 4.

Pipe 4 is closed at the lower end by a base 115, which sits on shaft 5.3 which is rotated about its axis by drive 5.2. Drive 5.2 is located outside container 1, wherein shaft 5.3 projects outwards through outlet 8. Drive 5.2 can however also be disposed inside pipe 4 corresponding to the embodiment according to FIGS. 1a and 1b.

In this embodiment, pipe 4 is mounted rotatably at the upper end by means of a shaft stub 116 in a bearing 117, which is advantageously a roller bearing. Bearing 117 is disposed inside a hood 118 covering pipe 4 at the upper end, to which line 12 is connected for the supply of the drying medium.

The embodiment according to FIG. 3a differs from the embodiment according to FIG. 3 solely in that pipe 4a has a larger diameter than in the embodiment according to FIG. 3. Since external perforated pipe 2 has the same diameter as in the previous embodiment, annular space 104 for bulk material 3 has a relatively small radial width. This reduction of the radial width of annular space 4 offers advantages with special bulk materials. On account of the larger diameter of pipe 4a and narrower annular space 104, the relative motion of bulk material 3 between the two pipes 2, 4a is greater. Agglomerates, which can be form during the crystallization of bulk material 3, are thus avoided or agglomerates that do arise are removed again.

Different bulk materials, which are to be converted from the amorphous into the crystalline state in a device by a heat treatment, can differ very greatly from one another in their physical properties in the conversion phase. In addition, there are different shapes of particles that are to be processed in the process.

Further bulk materials are also pure amorphous new goods with a low dust content and cylindrical or spherical regular granulates in small (2-3 mm) grain sizes or large grain sizes with up to 4 to 5 mm maximum lengths, which have a very high bulk density. For this material, the annular space can be more suitably constituted wide in order to increase the material quantity in the annular space. This measure leads to a longer dwell time of the material in the annular space, which is required for greater material thicknesses in order to dry the same.

Special bulk materials are also grinding material of films or bottles, which behave very differently in the bulk material fill. Thus, for example, film grinding stock from flat films, for example, can be very problematic, if the film shreds lie flat upon one another and the air passage is thus made difficult. The heating and the crystallization rate are then irregular. A smaller spacing between the two pipes 2, 4, 4a can certainly be helpful here, in order to mix the particles better by a more intense motion in the material.

Further physical properties of special bulk materials are the adhesiveness and the softening of the material in the conversion phase. There are partially crystalline plastics which develop only a slight tendency to adhesion. In contrast, there are plastics which can form very large agglomerates, since they develop a very marked tendency towards adhesion and can only be separated with difficulty after crystallization. Small fill thicknesses are then required for this, which lead to a high relative motion in the material. The spacing of pipes 2, 4, 4a should then be kept relatively small.

In the case of materials with a very high degree of softness in the conversion phase, but a low tendency towards adhesion, it is however then better to permit only a small relative motion in the material fill, which would certainly be possible with a broader fill.

Moreover, the embodiment according to FIG. 3a is constituted the same as the embodiment according to FIG. 3.

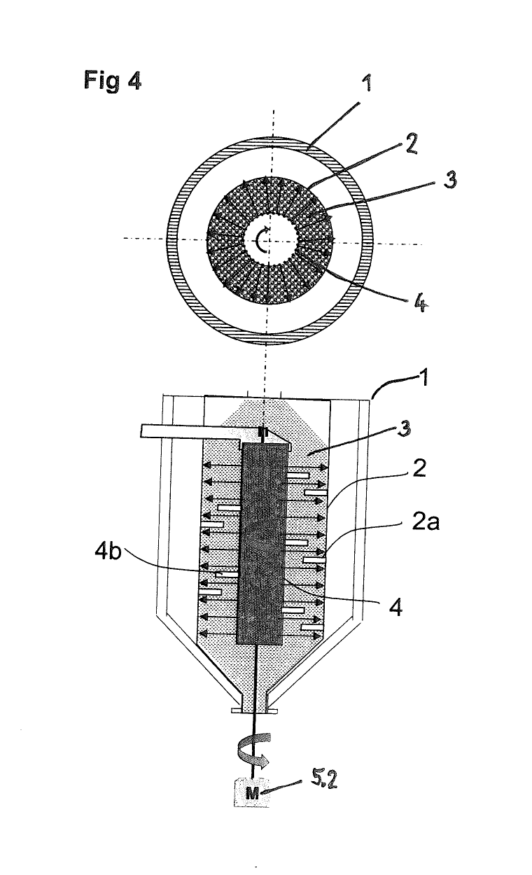

The embodiment according to FIG. 4 essentially corresponds to the embodiment according to FIG. 3. Internal pipe 4 driven rotatably by means of drive 5.2 is provided at its outer side with stirrer blades 4b, which project radially from the pipe casing and extend into bulk material 3. Stirrer blades 4b are positioned at a spacing above one another in the axial direction of pipe 4. Axially adjacent stirrer blades 4b are advantageously disposed offset at an angle with respect to one another. Two or more stirrer blades 4b can thus be disposed distributed around the circumference at the same axial height. In principle, however, it is sufficient if only one stirrer blade 4b is provided at each axial height. The arrangement and distribution of stirrer blades 4b is selected such that uniform mixing of bulk material 3 is possible over the height of pipe 4.

In order that bulk material 3 is not co-rotated, blades 2a projecting crosswise are provided at the inner side of external pipe 2, said blades being stationary and disposed in such a way that they lie in the region between axially adjacent stirrer blades 4b of internal pipe 4. Stirrer blades 4b and stationary blades 2a are of sufficient length that they advantageously overlap one another, viewed in the axial direction of the two pipes 2, 4. Stationary blades 2 are advantageously disposed distributed uniformly around the circumference.

Fixed blades 2a prevent bulk material 3 from being co-rotated by rotating pipe 4. In the interaction of rotating and stationary blades 2, 4b, bulk material 3 is mixed in the optimum manner and the formation of agglomerates in the bulk material is reliably prevented. Bulk material 3 is in turn only partially loosened and moved by stirrer blade 4b. The drying medium exiting from internal pipe 4 can thus dry the material 3 to the required extent within a short time.

Blades 2a, 4b can be constituted differently. Thus, for example, rods round in cross-section, but also rods in a blade shape can be used for the blades.

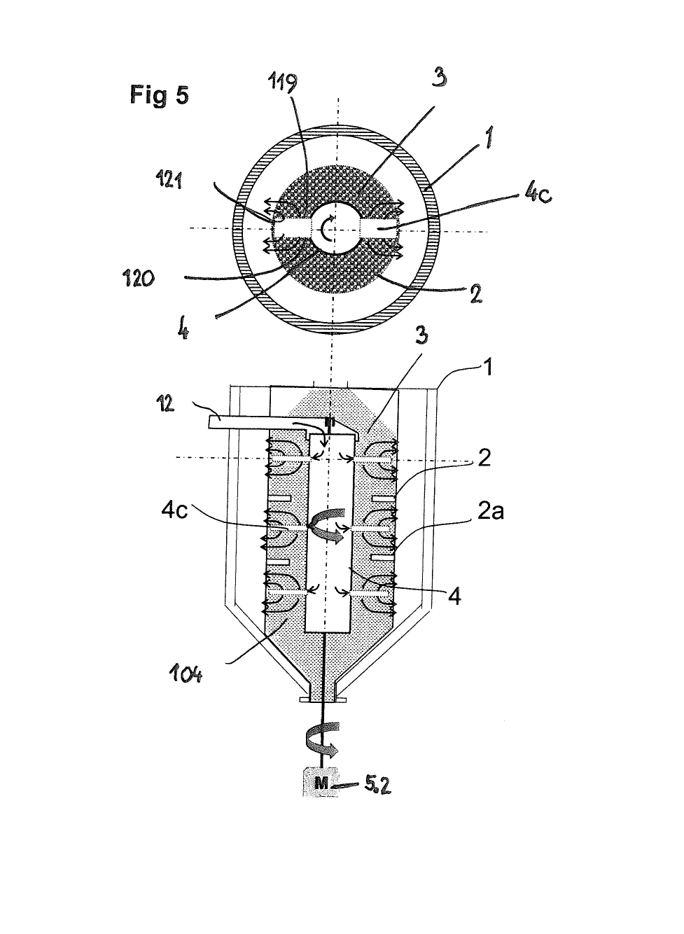

FIG. 5 shows an embodiment in which the drying medium is introduced via stirrer blades 4c into bulk material 3. In this case, pipe 4 can be constituted without perforation. It is of course also possible, however, for the casing of pipe 4 to be completely perforated or to be provided only partially with perforations. In contrast with the previous embodiment, stirrer blades 4c project almost up to the inner wall of external type 2, so that the drying medium exiting from stirrer blades 4c completely covers bulk material 3 in ring 104. Stirrer blades 4c are provided with a flat cross-section (FIG. 5), so that the stirrer blades have a much smaller width compared to their thickness measured in the axial direction of pipe 4. Stirrer blades 4c are provided at their longitudinal sides 119, 120 with outlet openings 121, via which the drying medium exits into bulk material 3. The outlet openings can also be provided in the upper side and lower side of stirrer blades 4c. In this case, corresponding outlet openings for the drying medium are present on all four sides of stirrer blade 4c. The outlet openings can also be provided only on one of the sides of stirrer blades 4c in each case.

The radially outer ends of stirrer blades 4c are closed. The radially inner ends are open towards the interior of internal pipe 4, so that the drying medium flowing in via line 12 can pass into stirrer blades 4c.

Outlet openings 121 can, for example, be round openings or slots, via which the drying medium flows into bulk material 3.

Stationary blades 2a are provided at the inner wall of external pipe 2, said stationary blades being provided on pipe 2 and being disposed relative to stirrer blades 4c in a similar manner to the previous embodiment.

Stirrer blades 4c are provided, for example, lying diametrically opposite one another at the same axial height of pipe 4. If pipe 4 is rotated about its axis by means of drive 5.2, bulk material 3 is partially moved by stirrer blades 4c. The interaction with stationary blades 2a prevents bulk material 3 from being caused to rotate due to the rotation of internal pipe 4. The drying medium does not pass into bulk material 3 simultaneously over the entire circumference and the axial height of pipe 4, but only partially in the region in which stirrer blades 4c are located inside bulk material 3. As in the previous embodiments, part of bulk material 3 is at rest, which reliably ensures that bulk material 3 can slide down without obstruction. As a result of the partial input of the drying medium, it is possible to introduce the drying medium into bulk material 3 at a particularly high speed, as a result of which the drying time is considerably reduced.

As a result of the introduction of the drying medium via stirrer blades 4c, the driving force of rotating internal pipe 4 is also reduced, since a grinding track arises around the stirrer blades 4c, in which the quantity of the drying medium is correspondingly high. Moreover, the contact between the drying medium and bulk material 3 on account of the parallel input of the drying medium is much better than when the drying medium is introduced into bulk material 3 simultaneously over the entire height and the entire circumference of internal pipe 4.

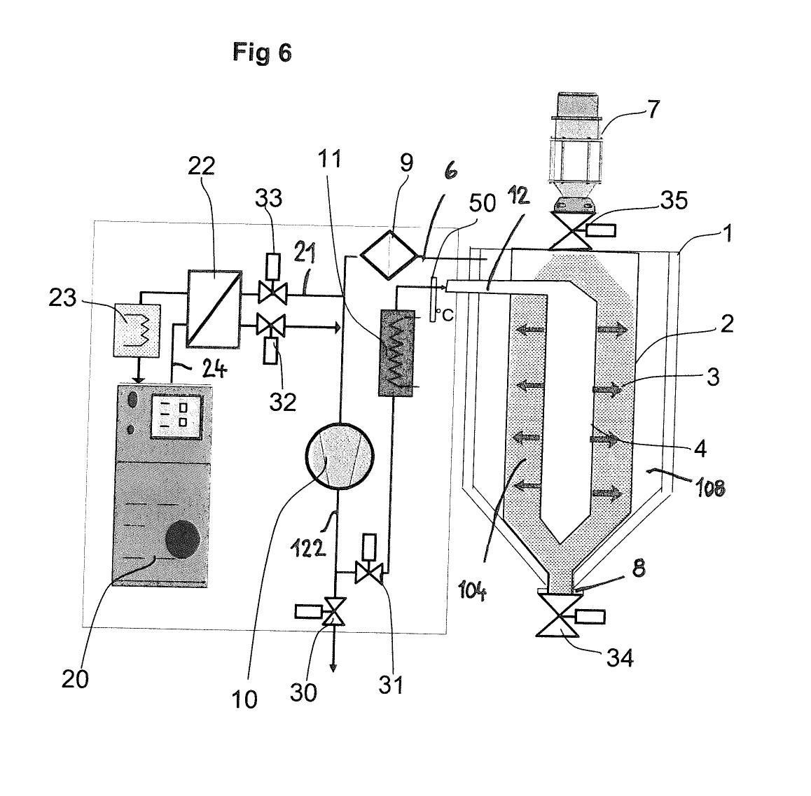

FIG. 6 shows a device with which the drying rate can be increased considerably. This is achieved by the fact that the vapor pressure difference between the drying medium and bulk material 3 to be dried is increased. To achieve this, bulk material 3 is placed in a phased manner under a partial vacuum. In a first phase, the drying medium exiting from pipe 4 flows at a high speed through bulk material 3 in annular space 104 between external pipe 2 and internal pipe 4. In a second phase, bulk material 3 is then subjected to a partial vacuum for a specific time. The effect of this alternating process management is that the drying process is accelerated very considerably.

The device according to FIG. 6 is basically constituted identical to the device according to FIG. 1. In order to generate the partial pressure, corresponding valves are present, which will be described in greater detail below.

The drying medium is fed by means of a blower 10 via a valve 31 to heating device 11, with which the drying medium is heated to the drying temperature as required. The drying medium passes via line 12 into internal pipe 4, which in this embodiment is a perforated pipe. The drying medium enters into bulk material 3 over the height and the circumference of pipe 4. The drying medium takes up the moisture from bulk material 3. The drying medium flows through perforated external pipe 2 and passes into annular space 108 between pipe 2 and the container casing. The drying medium loaded with moisture (return air) flows via return line 6 and filter 9 back to blower 10, which conveys the return air via opened valve 31 into line 12. Part of the return air passes in the flow direction behind filter 9 into line 21, in which a valve 33 sits. When it is opened, this part of the return air can flow, in the manner described with the aid of FIG. 1, via heat exchanger 22 and cooler 23 to dehumidification device 20. Here, the return air is dehumidified and conveyed via line 24 and heat exchanger 22 back to return line 6. The dried return air passes via blower 10 and heating device 11 into internal pipe 4. A valve 32, which is opened in the described circuit, is located between heat exchanger 22 and line 6.

In this phase, the method corresponds to the method such as is carried out with the device according to FIG. 1.

Located at the outlet of filling device 7 is a further valve 35, with which filling device 7 can be shut off, so that no bulk material 3 can be topped up into container 1. Provided at outlet 8 of container 1 is a further valve 34, with which outlet 8 can be opened and closed in a controlled manner by the valve.

Line 122 connected to the pressure side of blower 10, branched off from line 12, can be closed in the flow direction behind the connection of line 12 by a valve 30. During the described drying process, valve 30 which connects the device to the surroundings is closed. The described drying phase is relieved in specific cycles by the partial vacuum phase. In this case, a partial vacuum is generated in the device with the aid of blower 10. Valves 31 to 35 are closed and valve 30 is opened for this purpose. The effect of this is that blower 10 conveys the air out of the line system and container 1 via opened valve 30 to the exterior. A partial vacuum thus arises in the entire flow space inside the device and therefore also inside annular space 104 in which bulk material 3 is present. It is maintained a specific time.

Following termination of the partial vacuum phase, a switch is again made to the heating phase, whereby valve 31 is first opened to reduce the partial vacuum in the device. Valves 32 and 33 can then be opened, whilst valve 30 is closed. The drying of bulk material 3 then takes place again by means of the drying medium, which is conveyed via line 12 into internal pipe 4.

A constant change between a partial vacuum and heating takes place in the described manner. The loading of the container 1 and the removal of bulk material 3 from container 1 takes place in each case only during the heating phases. Valves 34 and 35 are opened for this purpose as required. As in the other embodiments, only small quantities of bulk material are fed and removed during this heating phase, so that a continuous bulk material throughput is maintained.

In the device according to FIG. 6, the two pipes 2, 4 are constituted as perforated pipes. In contrast with the embodiment according to FIG. 1, no further pipe is installed inside internal pipe 4. The drying medium, which passes via supply line 12 into internal pipe 4, thus flows out radially over the height and over the circumference of internal pipe 4 and flows through the bulk material present in annular space 104. The drying medium takes up the moisture from bulk material 3 and passes through the openings of external pipe 2 into annular space 108. From here, the air flows into return pipe 6 in the described manner.

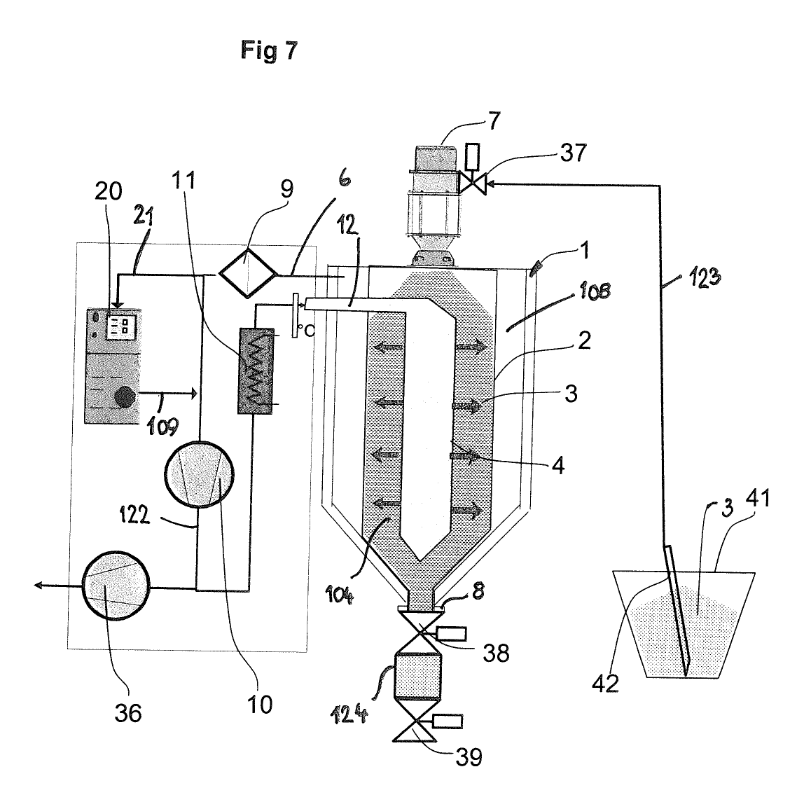

The device according to FIG. 7 comprises container 1 with the two pipes 2, 4, which are each constituted as perforated pipes. The drying medium is conveyed via line 12 into pipe 4 and exits the latter radially into bulk material 3. It lies in annular space 104 between the two pipes 2, 4. The drying medium takes up the moisture from bulk material 3, flows through external pipe 2 and passes into annular space 108, via which the drying medium loaded with moisture is fed via line 6 and filter 9 in blower 10. Part of this return air flows via line 21 into dehumidification device 20, in which this part of the return air is dehumidified. The dehumidified return air is fed via line 109 back to line 6 on the suction side of blower 10. The drying medium flows through heating device 11, by means of which it is heated to the drying temperature as required before entry into pipe 4

In this phase, the device operates in the same way as the device according to FIG. 1.

The device according to FIG. 7 has additional blower 36, with which a partial vacuum can be generated inside the device. Blower 36 is connected to line 122 and assigned to filling device 7 and produces the partial vacuum required for conveying the bulk material. Since drying medium is still present in the process circuit in the partial vacuum state, the drying medium can continue to be kept in the circuit by means of blower 10, in order to heat and thus to dehumidify bulk material 3. The partial vacuum, which thereby acts simultaneously, increases the vapor pressure difference between the drying medium and bulk material 3 to be dried. Blower 36 conveys the air present in the device at its pressure side into the surroundings, until the desired partial pressure is present in the device.

Connected via a suction line 123 to filling device 7 is a suction lance 42, which is introduced into a container 41 loaded with bulk material 3. Instead of container 41, use can also be made of any other bulk material source.

Suction line 123 is connected via valve 37 to filling device 7.

If container 1 is to be filled with bulk material 3, valve 37 is opened. Bulk material 3 is sucked by blower 36 out of container 41 by means of suction lance 42 into filling device 7. Bulk material 3 is preferably conveyed until such time as filling device 7 is filled. Valve 37 is then closed. The (not represented) valve at the outlet of filling device 7 is then opened, so that the bulk material can flow out of filling device 7 into annular space 104.

Connected to outlet 8 of container 1 are two valves 38 and 39, which form a lock for bulk material 3 removed from container 1. When the bulk material is removed, valve 39 is closed and valve 38 is opened. The bulk material can then pass into an intermediate space 124 between the two valves 38, 39. As soon as it is filled, valve 38 is closed and valve 39 is opened. The bulk material passes from the intermediate space 124, for example, into a processing machine.

The lock in the form of the two valves 38, 39 makes it possible to remove the bulk material from container 1 while a partial vacuum is present in the device.

In order that bulk material 3 removed from container 1 can be fed, for example, to a processing machine, a rotary lock valve, which permits a continuous bulk material flow, can, for example, also be used instead of the described lock.

With this device, there is the advantage that the partial vacuum is used additionally and simultaneously for the drying of the bulk material by means of the drying medium. The partial vacuum is provided in connection with filling device 7, which always operates with a partial vacuum for the filling of container 1. Filling device 7 is connected to the suction side of blower 36, so that bulk material 3 is sucked out of container 41. The partial vacuum thus generated also acts in annular space 104, in which bulk material 3 is present in container 1 for the drying process. As a result of the simultaneous use of the partial vacuum and the flow of the drying medium through bulk material 3, optimum drying of bulk material 3 results in the shortest possible time.

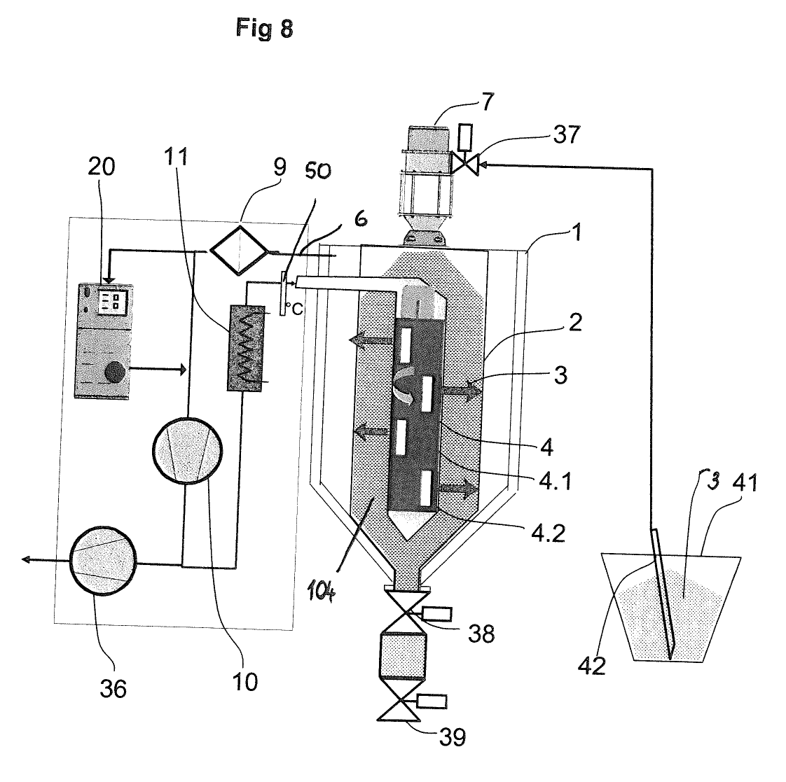

The two pipes 2, 4 are also constituted as perforated pipes in this device. In contrast with the device according to FIG. 1, there is inside internal pipe 4 no further pipe with which the perforations of internal pipe 4 can be partially covered. The drying medium conveyed via a line 12 into internal pipe 4 flows through bulk material 3 in annular space 104 and passes through the openings of external pipe 2 into annular space 108. From here, the drying medium loaded with moisture flows into the return line 6.

Whereas, in the case of the device according to FIG. 7, the two pipes 2, 4 are disposed stationary in container 1 and the drying medium passes via the perforated pipes into bulk material 3 and then into annular space 108, FIG. 8 shows a device in which internal pipe 4 is rotatable about its axis corresponding to the embodiment according to FIGS. 1, la and 1 b. The drive for pipe 4 can be provided outside container 1, but also inside container 1 (FIG. 1b). In this embodiment, as has been described on the basis of the device according to FIG. 1, the drying medium flows in a phased manner through bulk material 3 in annular space 104 between the two pipes 2, 4. The partial vacuum acts simultaneously on bulk material 3 in annular space 104, as has been described on the basis of FIG. 7.

In the device according to FIG. 8, an embodiment corresponding to FIGS. 2a to 2c and corresponding to FIGS. 3 and 3a can be used for internal pipe 4. Especially when use is made of pipe 4 corresponding to FIGS. 3 and 3a, the advantage arises that volatile components can escape from the material especially during the crystallization of thermoplastic polyesters. The process of a post-condensation can thus take place in the device, wherein the molecular chains of the polyester are lengthened again and acetaldehyde is expelled from the bulk material.

Finally, a pipe corresponding to FIG. 4 can also be used in the device according to FIG. 8, wherein rotating internal pipe 4 is provided with stirrer blades 4b and external pipe 2 is provided with stationary blades 2a. The formation of agglomerates during the crystallization is avoided by such an embodiment.

It is also possible to use the embodiment of internal pipe 4 according to FIG. 5 in the device according to FIG. 8. The drying medium exiting from stirrer blades 4c can be combined with the use of the described partial vacuum.

In the described device, temperature sensor 50 is provided in line 12, with the aid of which the drying process can be controlled very easily. The temperature of the drying medium introduced into pipe 4 is detected by means of temperature sensor 50. The reference temperature is the temperature of bulk material 3 at the exit of container 1. Both the temperature of the bulk material at the container exit and the temperature of the inflowing drying medium are detected. The temperature of the drying medium can thus be controlled or also regulated in a straightforward manner in such a way that bulk material 3 and container 1 is not heated to an inadmissibly high level.

Temperature sensor 50 can be provided at any suitable point inside the device. The described position of temperature sensor 50 directly before the entry of the drying medium into container 1 is advantageous.

Heating device 11 is controlled or also regulated corresponding to the detected temperatures of the drying medium and the bulk material at the container outlet in such a way that the drying medium always has the temperature required for optimum drying of bulk material 3.

With the described embodiments, the drying medium is fed via the internal pipe and, after flowing through bulk material 3, enters into annular space 108 through the through-openings of external pipe 2. From here, the return air passes into return line 6.

In the described embodiments, the drying medium can flow through bulk material 3, but also in the opposite direction. Accordingly, pipes 2, 4 and the built-in components are disposed and constituted in such a way that the drying medium can flow through external pipe 2 into bulk material annular space 104. After having flowed through bulk material 3, the drying medium passes into internal pipe 4 and is fed from there to return conveying line 6.

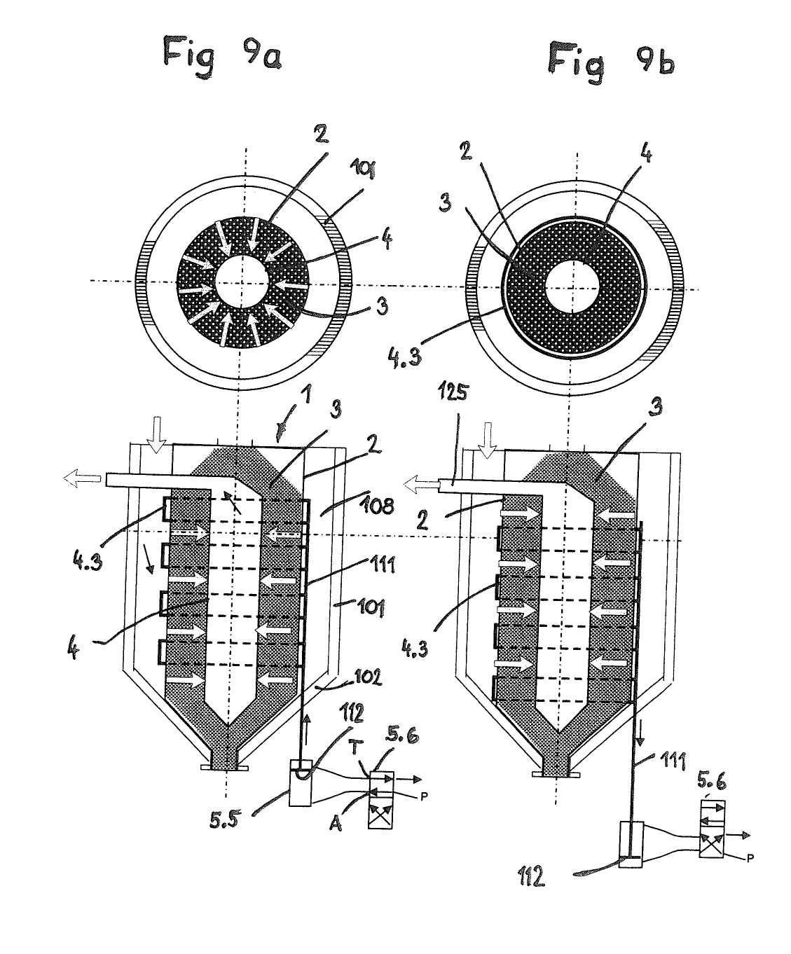

An exemplary embodiment of such a drying container is shown in FIGS. 9a and 9b. This embodiment is constituted similar to the embodiment according to FIGS. 2a and 2b. In this embodiment, external pipe 2 is surrounded by at least one tubular screen 4.3, which can be adjusted axially. In the embodiment, four tubular screens 4.3 lying spaced apart above one another are provided, which sit on common piston rod 111. By means of the latter, screens 4.3 can be displaced together axially along external pipe 2. The tubular screens have only a slight spacing from the outer wall of pipe 2, so that screens 4.3 can be reliably adjusted. The spacing is so small or the region between screens 4.3 and the outer wall of pipe 2 is sealed in such a way that the fed drying medium cannot pass between the outer wall of pipe 2 and screens 4.3. The drying medium can flow only in the region between screens 4.3 lying above one another through the openings of pipe 2 radially inwards into bulk material 3, as indicated by the flow arrows. Since screens 4.3 can be adjusted axially along pipe 2, different regions of pipe 2 can be freed for the passage of the drying medium depending on the position of screens 4.3.

The drying medium is introduced into annular space 108 between external pipe 2 and cylindrical mantle 101 of container 1.

Piston rod 111 projects into pneumatic cylinder 5.5, which can be actuated by means of switching valve 5.6. Piston 112 in pneumatic cylinder 5.5 can be acted upon on both sides. In the switching position according to FIG. 9a, the pressure medium is introduced via working connection A of switching valve 5.6 into pneumatic cylinder 5.5 in such a way that piston 112 is moved upwards. The pressure medium present in the other cylinder chamber is fed back to the tank via tank connection T of switching valve 5.6. Screens 4.3 sitting on piston rod 111 are correspondingly moved into the upper position represented in FIG. 9a. The drying medium flows in the direction of the drawn flow arrows in the region between screens 4.3 through pipe 2 radially inwards into bulk material 3.

If switching valve 5.6 is switched over (FIG. 9b), the pressurized medium passes into the upper cylinder chamber, as a result of which piston 112 is displaced downwards. The pressure medium present in the lower cylinder chamber is conveyed back to the tank. Screens 4.3 are moved by means of piston rod 111 into the other end position, in which screens 4.3 cover the regions of pipe 2 lying free in the switching position according to FIG. 9a. The drying medium now flows into bulk material 3 via the regions of pipe 2 which were covered by the screens in the switching position according to FIG. 9a.

Bulk material 3 is again acted upon only in sections by the drying medium. As in the embodiment according to FIGS. 2a and 2b, switching valve 5.6 can be switched over at identical time intervals in order to move screens 4.3 into the position according to FIG. 9a or into the position according to FIG. 9b. Depending on bulk material 3, it is also possible to switch over switching valve 5.6 in alternating time intervals.

The spacing between axially adjacent screens 4.3 advantageously corresponds to the width of screens 4.3. The effect of this is that, depending on the switching position, the regions of pipe 4 are always covered through which the drying medium is flowing into bulk material 3 in the respective other switching position.

In principle, it is also possible to select the spacings between screens 4.3 smaller or greater than the width of screens 4.3.

Piston rod 111 projects outwards through conical mantle 102 of container 1.

Not only pneumatic drives can be considered for the axial displacement of screens 4.3. Any suitable drives can be used.

After flowing through bulk material 3, the drying medium enters into internal pipe 4 and is fed from here via a line 125 to return line 6.

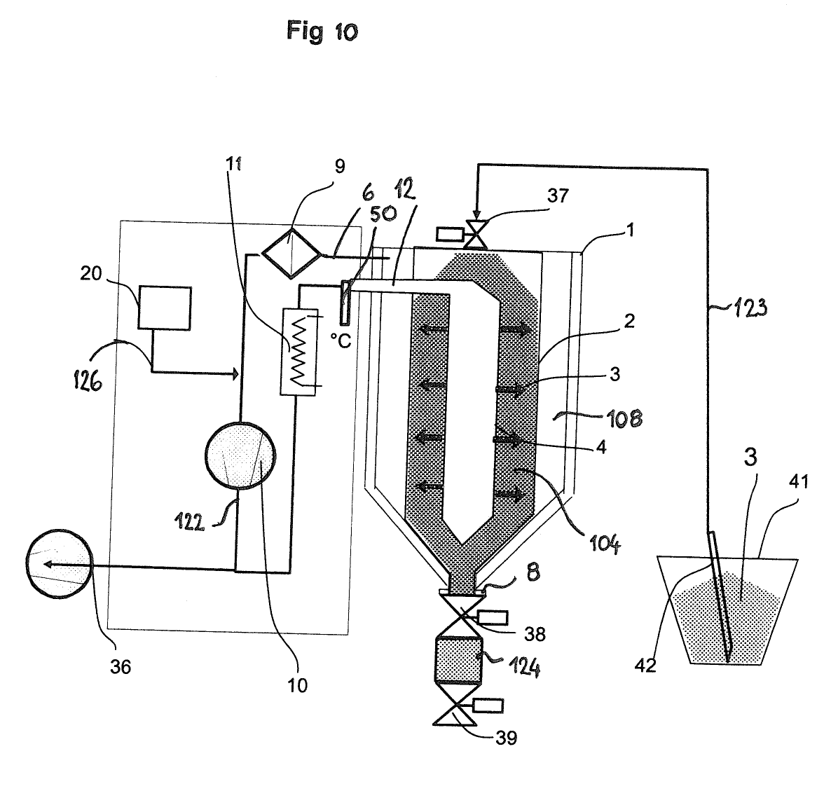

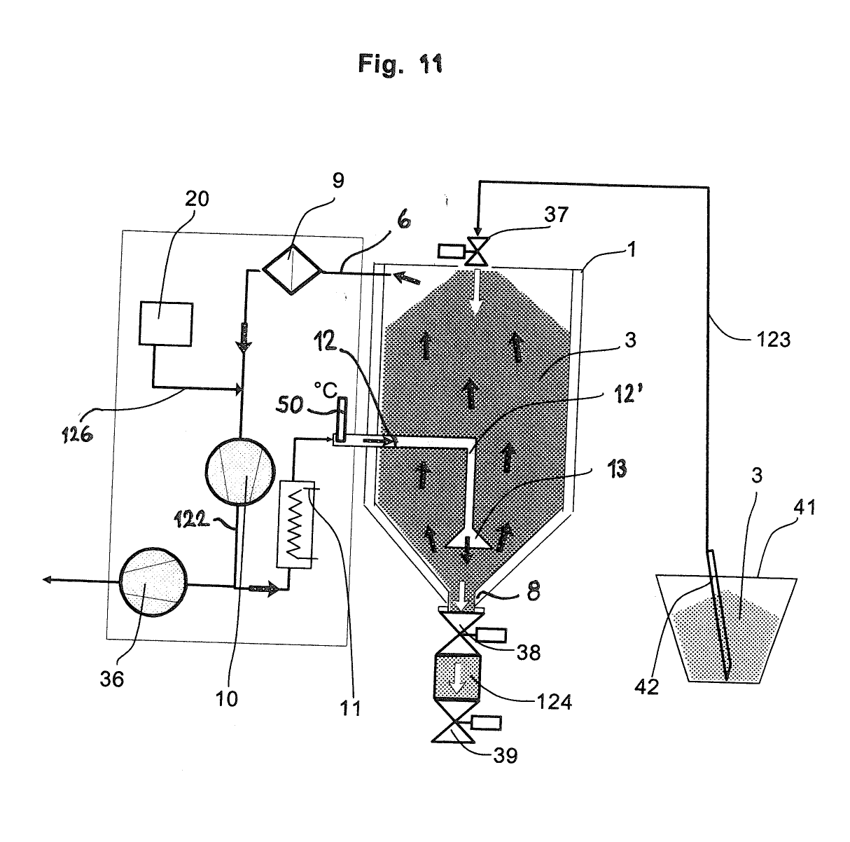

FIG. 10 shows a device which is constituted essentially the same as the device according to FIG. 8. The two pipes 2, 4 lying coaxially with respect to one another are perforated pipes, so that the drying medium, which passes via supply line 12 into internal pipe 4, can flow through its openings radially outwards into bulk material 3. The drying medium flows radially through bulk material 3 and passes through the openings of external pipe 2 outwards into annular space 108. During the passage through bulk material 3, the drying medium picks up moisture and passes as return air into return air line 6. The return air is sucked by blower 10 and flows through filter 9 and, before entry into the drying container, is heated as required by means of heating device 11. The drying medium is thus conveyed in the circuit via line 6, line 122 and line 12 and is thereby heated, as required, by means of heating device 11.

In contrast with the embodiment according to FIG. 8, part of the return air is not branched off to dehumidification device 20. On the contrary, dehumidified drying medium is introduced from dehumidification device 20 via a line 126, as required, into return line 6 before blower 10.

Also in contrast with the device according to FIG. 8, no internal pipe with screen openings is present in pipe 4. The drying medium thus exits radially into annular space 104 over the height and the circumference of pipe 4, in which annular space bulk material 3 to be dried is present.

The drying process can be controlled in a straightforward manner by means of a temperature sensor 50, which is provided in supply line 12 before the entry into the drying container, as is illustrated in connection with the embodiment according to FIG. 8.

If container 1 is to be filled with bulk material 3, valve 37 is opened. As has been explained on the basis of the embodiment according to FIG. 7, bulk material 3 is sucked by means of blower 36 out of container 41 by means of suction lance 42 via suction line 123. Valve 37 is opened, so that bulk material 3 can pass into annular space 104 between the two pipes 2, 4. Located at outlet 8 of drying container 1 is the lock with the two valves 38, 39 and intermediate space 124 located between the latter. As has been described in detail on the basis of the embodiment according to FIG. 7, the lock at outlet 8 of the drying container makes it possible for the bulk material to be removed while a partial vacuum is present in the entire device. Container 41 is connected to the suction side of blower 36, so that bulk material 3 is sucked out of container 41. The partial vacuum thus generated also acts in annular space 104. As a result of the simultaneous use of the partial vacuum and the through-flow of bulk material 3 by the drying medium, bulk material 3 is effectively dried in the shortest possible time.

FIG. 11 shows a device in which bulk material 3 fills the interior of drying container 1. In contrast with the previous embodiments, no internal and external pipes are present in drying container 1.

As for the rest, the device according to FIG. 11 is constituted essentially the same as the device according to FIG. 10. The drying medium is conveyed by means of a blower 10 via heating device 11 into supply line 12. It projects up to the middle of drying container 1 and is directed downwards inside drying container 1. Located at the lower end of this vertical line section 12′ is a downwardly directed funnel 13, which ends at a distance from outlet 8 of the drying container and from which the drying medium exits downwards. The drying medium indicated by arrows flows downwards out of funnel 13 into bulk material 3. The drying medium flows upwards through bulk material 3 and thereby picks up moisture from the bulk material. The drying medium flows out of drying container 1 via return line 6. The drying medium loaded with moisture flows through filter 9 and, before its renewed entry into drying container 1, is then heated as required by heating device 11. Temperature sensor 50 detects, in the described manner, the temperature of the drying medium upon entry into drying container 1.

Dehumidified air is fed via dehumidification device 20 and line 126 to return line 6 as required.

As for the rest, the device operates in the same way as has been described on the basis of FIGS. 7, 8 and 10. By means of blower 36, the partial vacuum is generated in the device, which is used additionally and simultaneously to dry the bulk material. As a result of the simultaneous use of the partial vacuum and the through-flow of bulk material 3 by the drying medium, excellent drying of the bulk material in turn results in the shortest possible time.

As in the embodiments according to FIGS. 7, 8 and 10, the partial vacuum is generated by blower 36, which is also used to fill drying container 1 with bulk material 3. The partial vacuum is also present in closed heating circuit 6, 9, 10, 122, 11, 12, as a result of which optimum drying results in only a short time.

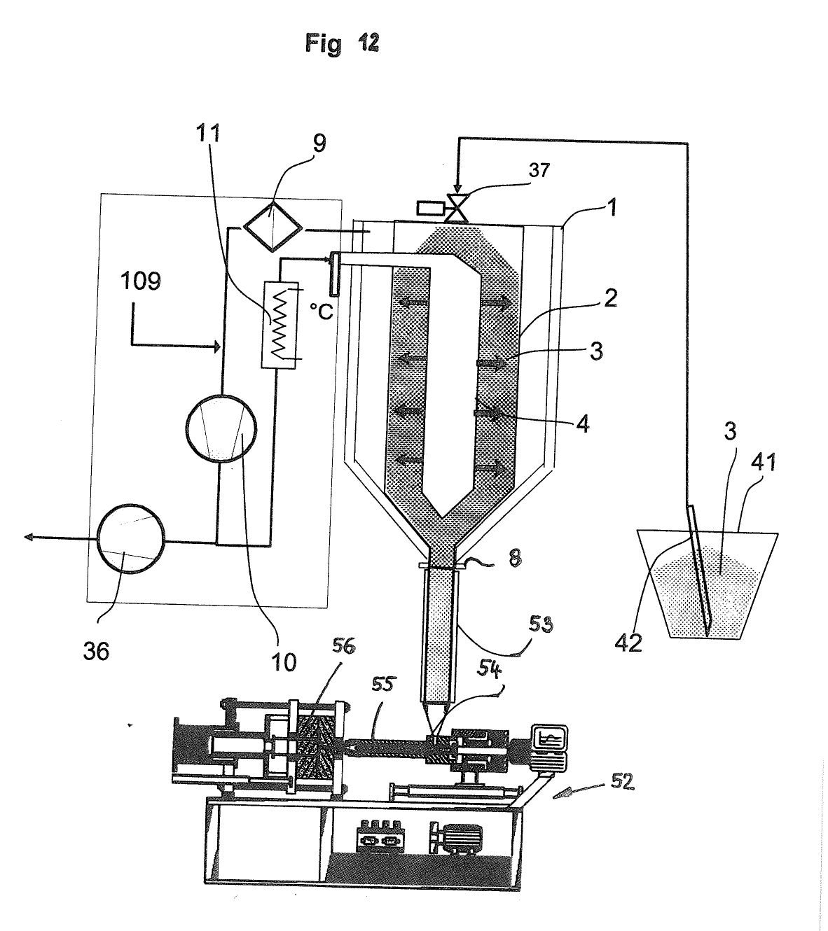

The device represented in FIG. 12 corresponds to the device according to FIG. 10. Drying container 1 is connected to a processing machine 52, with which bulk material 3 is processed. Bulk material 3 passes from outlet 8 of drying container 1 into a supply line 53, which feeds bulk material 3 to a melting zone 54 of processing machine 52. The bulk material passes via this melting zone 54 into an extruder screw 55, with which bulk material 3 passes in a molten state into an only diagrammatically represented injection mould 56. By means of the latter, the given article is produced from the molten bulk material 3.

The described partial vacuum in the device, produced by blower 36, also acts via supply line 53 in melting zone 54 of processing machine 52. Any out-gassing moist particles or other volatile substances can thus be removed from the bulk material right at the start of the melting phase. These gases are then removed from the process by means of blower 36.

In all the described embodiments, it is possible according to the device according to FIG. 12 for the partial vacuum also to prevail in the melting zone of processing machine 52. FIG. 12 is only an embodiment, which however is to be understood as non-limiting with respect to the other embodiment of the device.

In the embodiments according to FIGS. 6 to 12, blower 36 is provided as a partial vacuum generator, with which bulk material 3 can also be sucked into drying container 1. The partial vacuum in the device can however also be generated by any other device generating a partial vacuum.

What is claimed is:

1.-26. (canceled)

27. A method for drying and/or crystallizing bulk material, the method comprising:
passing a drying medium through bulk material present in a drying chamber;
putting the drying chamber with the bulk material under a partial vacuum at least for part of a drying time of the bulk material.

28. The method according to claim 27, further comprising applying alternately the drying medium and the partial vacuum to the bulk material.

29. The method according to claim 27, further comprising applying simultaneously the drying medium and the partial vacuum to the bulk material.

30. The method according to claim 27, further comprising putting additionally a heating circuit connected to the drying chamber under the partial vacuum.

31. The method according to claim 27, further comprising putting additionally a melting zone of a processing machine under the partial vacuum.

32. The method according to claim 27, further comprising passing the drying medium only partially through the bulk material and directing a drying medium flow of the drying medium such that successively all regions of the bulk material are reached by the drying medium flow.

33. The method according to claim 27, further comprising introducing the drying medium into the bulk material at different speeds.

34. The method according to claim 27, further comprising conveying the drying medium in circulation through a drying container and feeding part of the drying medium through a dehumidification device after the drying medium has flowed through the bulk material.

35. The method according to claim 34, further comprising returning the part of the drying medium that has been fed through the dehumidification device to the drying medium that is being conveyed to the drying container.

36. A device for performing the method according to claim 27, the device comprising:
at least one drying container comprising a drying chamber for bulk material;
at least one supply line for a drying medium connected to the at least one drying container;
at least one return air line connected to the at least one drying container;
at least one partial-vacuum generator configured to put at least the drying chamber under a partial vacuum at least for part of a drying time of the bulk material.

37. The device according to claim 36, further comprising a filling device for the bulk material, wherein the partial-vacuum generator is a blower comprising a suction side, wherein the filling device is connected to the suction side of the blower.

38. The device according to claim 36, further comprising a material lock connected to an outlet of the at least one drying container, wherein the material lock comprises two valves between which an intermediate space for the bulk material is disposed.

39. The device according to claim 36, further comprising a processing machine comprising a melting zone, wherein an outlet of the drying container is connected by at least one line to the melting zone.

40. The device according to claim 36, wherein the drying container is configured to feed the drying medium into the drying chamber in such a way that the bulk material in the drying chamber is always acted upon only partially by the drying medium.

41. The device according to claim 40, wherein the at least one drying container comprises an internal pipe and an external pipe surrounding the internal pipe, wherein the drying chamber is formed between the external pipe and the internal pipe, and wherein the external pipe and the internal pipe each comprise through-openings for the drying medium.

42. The device according to claim 41, further comprising built-in components provided on one of the external and internal pipes, wherein the built-in components implement a partial flow of the drying medium through the bulk material.

43. The device according to claim 42, wherein the built-in components are formed by an inner pipe or an outer pipe mounted rotatably in the internal pipe or on the external pipe.

44. The device according to claim 43, wherein the inner pipe or outer pipe comprises at least one through-opening through which the drying medium passes.

45. The device according to claim 43, wherein openings of the internal pipe or of the external pipe are covered by the inner pipe or the outer pipe, except for areas where the at least one through-opening is located.

46. The device according to claim 43, further comprising a drive connected to the inner pipe or the outer pipe, wherein the drive is disposed outside of or inside the drying container.

47. The device according to claim 42, wherein the built-in components are formed by at least one screen arranged so as to be axially displaceable in the internal pipe or on the external pipe.

48. The device according to claim 47, wherein the at least one screen covers some of the openings of the internal pipe or of the external pipe.

49. The device according to claim 42, wherein the built-in components are formed by at least one stirrer blade projecting from the internal pipe or from the external pipe into the drying chamber, wherein the internal pipe or the external pipe is configured to rotated about an axis of the internal pipe or the external pipe, respectively.

50. The device according to claim 49, wherein an inner wall of the external pipe or an outer wall of the internal pipe is provided with at least one projecting blade projecting into the drying chamber, wherein the at least one projecting blade, viewed in an axial direction of the internal pipe or the external pipe, overlaps the at least one stirrer blade.

51. The device according to claim 49, wherein the at least one stirrer blade is a hollow body into which the drying medium flows and which comprises at least one outflow opening for the drying medium.

52. The device according to claim 36, wherein the at least one drying container comprises at least one internal pipe and at least one external pipe surrounding the internal pipe, wherein between the external and the internal pipes the drying chamber is formed, and wherein the external pipe or the internal pipe is a perforated pipe that is configured to be rotated about an axis of the perforated pipe by a drive.
